(19) United States
(12) Patent Application Publication
(10) Pub. No.: US 2017/0127473 A1
(43) Pub. Date: May 4, 2017

(54) DUAL CONNECTIVITY MANAGEMENT

(71) Applicant: NOKIA TECHNOLOGIES OY, Espoo (FI)

(72) Inventors: Elena VIRTEJ, Espoo (FI); Jari LUNDEN, Espoo (FI)

(73) Assignee: Nokia Technologies Oy

(21) Appl. No.: 15/318,968

(22) PCT Filed: Jun. 24, 2014
(86) PCT No.: PCT/FI2014/050507

§ 371 Date: Dec. 14, 2016

(51) Int. Cl. H04W 76/06; H04W 76/02; H04L 5/00; H04W 76/04

(52) U.S. Cl. CPC H04W 76/068; H04W 76/046; H04W 76/025; H04L 5/0032; H04W 36/0027

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus to perform at least the following: receive configuration information including a timer value associated with user data inactivity; start or restart a timer when user data is active in at least one cell of a secondary cell group but not when user data is active in a cell of master cell group; and release dual connectivity if the timer expires.

### TECHNICAL FIELD

The present application relates to wireless communications and, in particular, dual connectivity management in a heterogeneous network.

### BACKGROUND

The expected increase in wireless data transmissions may mean that there will be a need to deploy more network capacity. One efficient way to increase the network capacity is by deploying small cells for offloading purposes or offloading cells in general. These small cells can be deployed on the same or separate carriers relative to the macro cell, and the mixed environment with macro/large cells and small cells are often referred to heterogeneous networks (hetnets). Use of hetnets may provide opportunities for offloading traffic from the macro cells to, for example, a higher speed or a higher capacity small cell.

The heterogeneous network may include one or more wireless access points, or base stations, such as for example an E-UTRAN (evolved Universal Mobile Telecommunications System Terrestrial Radio Access Network) NodeB base station serving macro cells, and one or more small cell base stations serving small cells. For example, a small cell base station (or a wireless access point or a remote radio head, for example) may be implemented to cover a small cell, or coverage area, examples of which include a residence, a small business, a building, an office, or a small area. The small cell base station, such as for example a home base station (HNB), a home E-UTRAN NodeB base station (HeNB), a WiFi access point, and the like, may be configured to have some of the functionality found in a typical base station, such as for example an E-UTRAN NodeB (eNB) base station, but the small cell base station may have less/smaller coverage/range and lower power capabilities given its limited coverage area or class. Furthermore, small cell base station may have limited (or non-ideal) backhaul connection that may have higher latency or lower throughput than macro cell base stations. This limited backhaul connection may affect communication between small cell base station and other base stations and other network elements or nodes. For example, the small cell base station may be implemented as a femtocell wireless access point/base station having power sufficient for a cell serving wireless devices within a limited range of about tens of meters. Picocell base stations are another example of a small cell base station, but picocell base stations have somewhat greater range serving a small area on the order of about 100-200 meters. The small cell base station may be implemented as a secondary base station, for example, a secondary cell (SCell) eNB in carrier aggregation. It may also be called a secondary eNB (SeNB). Accordingly, wireless service providers view small cell base stations as a way to extend service coverage into a small cell, as a way to offload traffic to the small cell base stations, and/or as a way to provide enhanced service, such as for example higher data rates, lower latencies, energy efficiency and the like, within the small cell, when compared to the larger macro cell served by a typical base station, such as for example the eNB base station. The macro cell base station may be also implemented as a primary base station, for example, a primary cell (PCell) eNB in carrier aggregation and may also be called master eNB (MeNB).

### SUMMARY

Various aspects of examples of the invention are set out in the claims.

According to a first aspect of the present invention, an apparatus comprising: at least one processor; and at least one memory including computer program code, wherein the at least one memory and the computer program code are configured to, with the at least one processor, cause the apparatus to perform at least the following: receive configuration information including a timer value associated with user data inactivity; start or restart a timer when user data is active in at least one cell of a secondary cell group but not when user data is active in a cell of master cell group; and release dual connectivity if the timer expires.

According to a second aspect of the present invention, a method comprising: receiving configuration information including a timer value associated with user data inactivity; starting or restarting a timer when user data is active in at least one cell of a secondary cell group but not when user data is active in a cell of master cell group; and releasing dual connectivity if the timer expires.

According to a third aspect of the present invention, a computer program product comprising a non-transitory computer-readable medium bearing computer program code embodied therein for use with a computer, the computer program code comprising: code for receiving configuration information including a timer value associated with user data inactivity; code for starting or restarting a timer when user data is active in at least one cell of a secondary cell group but not when user data is active in a cell of master cell group; and code for releasing dual connectivity if the timer expires.

According to a fourth aspect of the present invention, an apparatus comprising: at least one processor; and at least one memory including computer program code, wherein the at least one memory and the computer program code are configured to, with the at least one processor, cause the apparatus to perform at least the following: transmit configuration information including a timer value associated with user data inactivity, wherein the timer value is associated with release of dual connectivity if a timer which counts time of user data inactivity expires.

According to a fifth aspect of the present invention, an apparatus comprising: means for receiving configuration information including a timer value associated with user data inactivity; starting or restarting a timer when user data is active in at least one cell of a secondary cell group but not when user data is active in a cell of master cell group; and releasing dual connectivity if the timer expires.

According to a sixth aspect of the present invention, an apparatus comprising: means for transmitting configuration information including a timer value associated with user data inactivity, wherein the timer value is associated with release of dual connectivity if a timer which counts time of user data inactivity expires.

### BRIEF DESCRIPTION OF THE DRAWINGS

For a more complete understanding of example embodiments of the present invention, reference is now made to the following descriptions taken in connection with the accompanying drawings in which:

FIG. 1 depicts an example of a heterogeneous network in which some embodiments of the present invention may be practiced;

FIG. 2 depicts an example process for releasing dual connectivity in accordance with some example embodiments;

FIG. 3 illustrates a block diagram of a user equipment in accordance with some example embodiments; and

FIG. 4 illustrates a block diagram of a base station in accordance with some example embodiments.

### DETAILED DESCRIPTION OF THE DRAWINGS

Dual connectivity refers to the scenario that a user equipment (UE) is connected simultaneously to two different base stations, for example, one macro cell base station which may also be called master base station or MeNB, and one small cell base station which may also be called secondary base station or SeNB. Master cell group (MCG) refers to a group of serving cells associated with MeNB. MCG includes at least a PCell, it may also have one or more SCells. Secondary cell group (SCG) refers to a group of serving cells associated with SeNB. SCG includes small cells, for example, a primary SCell which carries physical uplink control channel (PUCCH) information, it may also include one or more other SCells.

Controlling large number of small cells in SCG and UE mobility to the small cells or activation of the small cells can cause notable overhead to the system. Therefore it is desirable to have a mechanism that can reduce this overhead by giving more autonomy to UE while at the same time keeping the control of UE mobility, for example, PCell handover, at the network.

The subject matter disclosed herein provides a way for UE with dual connectivity to macro cell and small cell to release dual connectivity under certain conditions. Specifically, there is provided a way of configuring an inactivity timer and starting or restarting the timer when user data is active in at least one cell of SCG but not when user data is active in a cell of MCG—allowing the UE to release dual connectivity when the inactivity timer expires, which will save UE power because unused SCell connection is released, and if it so chooses, informing the macro cell about the releasing of dual connectivity.

It is noted that macro cell (or MeNB) and small cell (or SeNB) are used and will be hereinafter described for purposes of example, other cell sizes or types can be used as well according to the invention. It is also noted that LTE and WiFi are used and will be hereinafter described for purposes of example, other radio access technologies can be applied as well. Furthermore, it is noted that the invention could be applied at least in part to device to device (D2D) connection. For example, UE's connection to network is master and D2D connection is the secondary or vice-versa. Moreover, dual connectivity may also be between the same power class base stations/wifi spots, not just between a macro cell eNB and a small cell eNB.

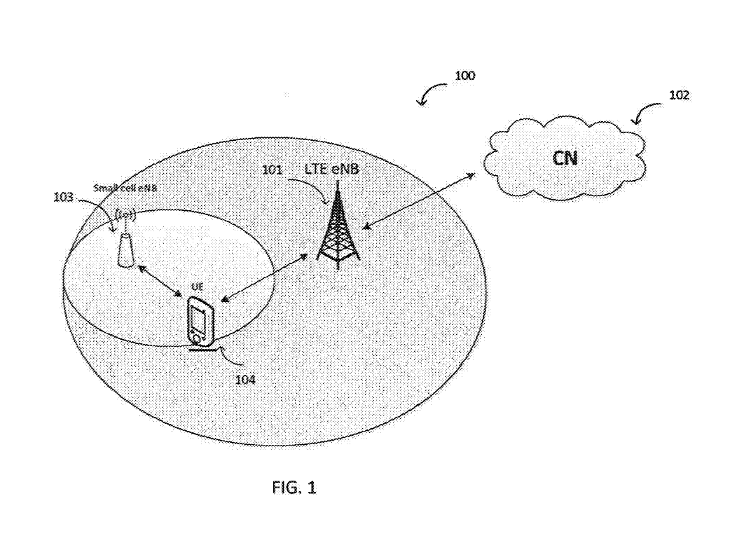

FIG. 1 illustrates an example heterogeneous network 100 in which some example embodiments of the present invention may be practiced. As illustrated in FIG. 1, in the heterogeneous network 100, a UE 104 is in connection with a MeNB 101 and a SeNB 103. The UE 104 may have dual connectivity, where the UE consumes radio resources provided by at least two different network points (MeNB 101 and SeNB 103) connected, for example, with non-ideal backhaul. The coverage areas of the eNBs are depicted by ellipses of different sizes, wherein the coverage area of the MeNB 101 is much larger than that of the SeNB 103 and overlays the coverage area of the SeNB 103. Within the same coverage area of the MeNB 101, UE's movement among small cells may lead to handover or reselection among small cells. The MeNB may be in connection with core network 102, for example, mobility management entity (MME) and serving gateway (S-GW), via S1 interface. In some example embodiments, the SeNB may be connected to the core network via MeNB. In some other example embodiments, the small cell eNB may be directly in connection with core network 102.

When bearer splitting is supported, a network may be more flexible regarding in which cell the network schedules the UE, but the macro-cell connection may still act as a backup if the small-cell connection fails for some reason. Bearer splitting means that a bearer, for example, an EPS bearer, can be routed via more than one eNB, for example, MeNB and SeNB in dual connectivity. Reference can be made to 3GPP TS 36.842 V12.0.0 (2013-12) 3rd Generation Partnership Project; Technical Specification Group Radio Access Network; Study on Small Cell enhancements for E-UTRA and E-UTRAN; Higher layer aspects (Release 12). This is similar to LTE Rel 10/11 carrier aggregation where one bearer can be scheduled via multiple cells. Reference can be made to 3GPP TS 36.211 V10.7.0 (2013-02) 3rd Generation Partnership Project; Technical Specification Group Radio Access Network; Evolved Universal Terrestrial Radio Access (E-UTRA); Physical Channels and Modulation (Release 10). In carrier aggregation, however, the two or more cells are served by the same eNB whereas in dual connectivity at least some of the cells are served by another eNB. Therefore, the macro cell layer may offer similar mobility robustness regardless of the type of cell that the UE is using to exchange data.

When bearer switch is supported, a bearer, for example, an EPS bearer, may be routed via only one eNB, for example, MeNB or a SeNB.

In some example embodiments, UE 104 may be implemented as a mobile device and/or a stationary device. The UE may be referred to as, for example, a wireless device, a mobile station, a mobile unit, a subscriber station, a wireless terminal, a tablet, a smart phone, a smart watch, and/or the like. In some example embodiments, UE 104 may be implemented as multi-mode user devices configured to operate using a plurality of radio access technologies, although a single-mode device may be used as well. For example, UE 104 may be configured to operate using a plurality of radio access technologies including one or more of the following: Long Term Evolution (LTE), wireless local area network (WLAN) technology, such as 802.11 WiFi and the like, Bluetooth, Bluetooth low energy (BT-LE), near field communications (NFC), and any other radio access technologies. The UE may be located within the coverage area of a cell or multiple cells.

Although FIG. 1 depicts a certain quantity and configuration of devices, other quantities and configurations may be implemented as well. For example, other quantities and configurations of base stations/access points, cells, and user equipment may be implemented as well.

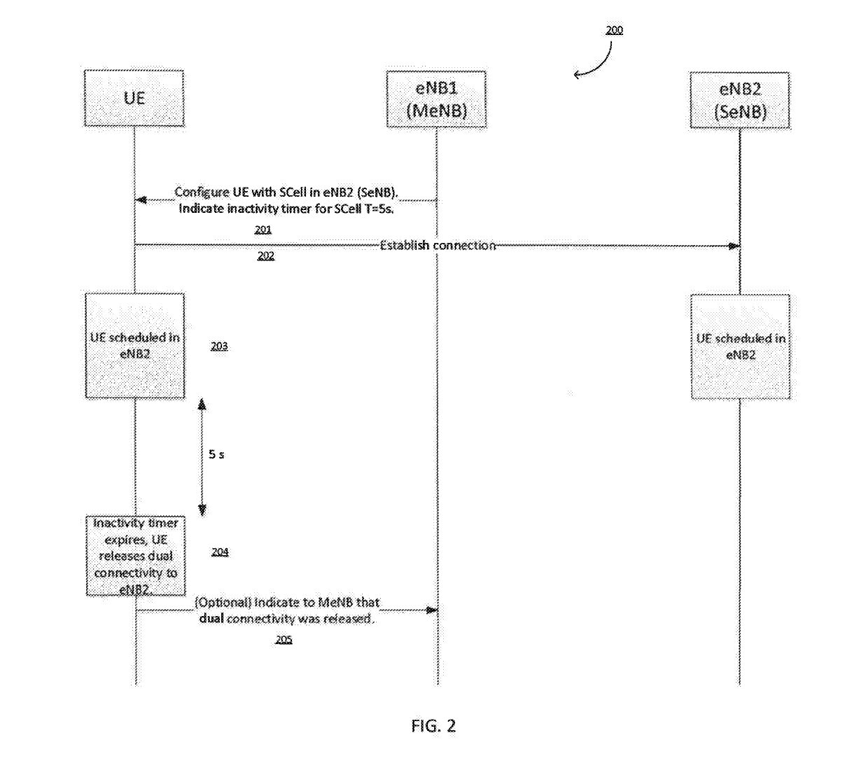

FIG. 2 depicts an example process for releasing dual connectivity in accordance with some example embodiments.

At 201, UE 104 may receive configuration information including among other things a timer value associated with user data inactivity from MeNB 101. The timer may be configured by the network, for example, MeNB 101. The timer value may be received from a radio resource control (RRC) message. For example, the timer value may be carried on a field in RRCConnectionReconfiguration message which is used for adding or configuring a SCell in SCG. The field may contain the value of timer T, for example, as a selection from a range of values. Reference can be made to 3GPP TS 36.331 V12.1.0 (2014-03) 3rd Generation Partnership Project; Technical Specification Group Radio Access Network; Evolved Universal Terrestrial Radio Access (E-UTRA); Radio resource control (RRC); Protocol specification (Release 12). The timer value may be specific for a SCell of SCG or common to all cells of SCG.

At 202, UE 104 establishes connection with a cell of SeNB 103. It is noted that step 202 may occur before step 201, that is, UE 104 may establish connection with a cell of SeNB 103 before receiving configuration information including a timer value associated with user data inactivity, or the time since the last activity, for the cell from MeNB 101. In this case, the timer value may be received, for example, from a re-configuration message, an update message, or the like.

At 203, UE 104 starts or restarts a timer when user data is active, for example, user data on a data radio bearer (DRB) is transmitted or received, in a cell of SCG but not when user data is active in a cell of MCG. In some example embodiments, UE 104 may start or restart a timer when UE 104 is scheduled with user data in a cell in SCG but not when UE 104 is scheduled in a cell of MCG. It is noted that in some embodiments transmitting control elements, such as buffer status report (BSR) and/or power headroom report (PHR), may not be considered as user data activity or being scheduled. The purpose of the timer is to count the time of user data inactivity in any of the cells in SCG, for example, the time since last time UE 104 was scheduled with user data in any of the cells in SCG. So the timer is started or restarted from its initial value (e.g. zero) every time UE 104 is scheduled. For MCG, the timer is not started or restarted when UE 104 is scheduled in one of the cells of MCG.

If user data is inactive for a period of time which is the configured timer value, for example, UE 104 is not scheduled in SCG for 5 seconds as an example (other values may be used as well), the timer would expire. At 204, UE 104 releases dual connectivity, that is, UE 104 releases connections to all cells of SCG. UE 104 may not release S1 connection, but instead may de-configure dual connectivity, for example, UE 104 de-configures dual connectivity related configurations such as BSR and/or PHR reporting rules toward SeNB and/or MeNB. In some example embodiments, there may be a configuration where UE 104 may stop sending BSR and/or PHR to SeNB after certain time of inactivity of user data in SCG. This will save UE power without releasing dual connectivity. UE 104 may still maintain its connection via cells in MeNB. In some example embodiments, dual connectivity may be released even when UE is having active data, just that there is no data through the cells of SeNB.

In some example embodiments, UE 104 having a split bearer monitors user data activity in both MeNB and SeNB. If the split bearer is inactive in both MeNB and SeNB for certain period of time, for example, the timer value configured by the network, dual connectivity may be released. Thus the bearer becomes only MCG bearer from the split bearer.

In some example embodiments, UE 104 may, at 205, indicate to MeNB that dual connectivity was released. In some example embodiments this indication may be signaled using a MAC control element defined for this purpose. In some other example embodiments RRC signaling may be used. In some example embodiments, UE 104 may indicate to MeNB before releasing dual connectivity, and UE may also wait for MeNB to acknowledge or allow this before releasing dual connectivity. In some example embodiments, UE may at 204 instead of releasing dual connectivity, deactivate it after the timer expires.

In some example embodiments, the autonomous releasing of dual connectivity by a UE may be used for a split bearer, for example, user plane architecture option 3 defined in 3GPP TS 36.842 V12.0.0 (2013-12) 3rd Generation Partnership Project; Technical Specification Group Radio Access Network; Study on Small Cell enhancements for E-UTRA and E-UTRAN; Higher layer aspects (Release 12). For option 3, user plane data terminates at MeNB and bearer split in radio access network. In some example embodiments, the autonomous releasing of dual connectivity may be configured on a bearer by bearer basis, e.g. separately enabled/disabled and configured for each bearer.

In addition to autonomous release of dual connectivity, in some example embodiment, UE 104 may initiate dual connectivity. A network element, such as MeNB, may provide configuration information for UE to initiate dual connectivity. For example, MeNB may provide a list of cells for which dual connectivity is supported. For example, a range of physical cell identity (PCI) or a list of PCI. MeNB may provide one or more carriers, possibly with some blacklisted cells, for which dual connectivity is supported. In other words, the network may configure UE with a list of cells (PCI range, list of PCI, plus possibly carrier/measurement object), or a carrier (with possibly some blacklisted cells), for which dual connectivity is supported. In some example embodiments, the UE may autonomously activate and/or deactivate dual connectivity for the configured cells. UE may transition or request transition between dual connected and single connected states based on its autonomous decision or based on configuration (e.g. timer for inactivity, or thresholds for current or expected future traffic) configured by the network. The request for transition or transition may be signaled, for example, using MAC control element defined for this purpose.

In some example embodiments, when certain criteria is satisfied, UE may access a cell in the list, for example, through random access channel (RACH), and establish a connection requesting dual connectivity. The criteria may be one or more of, for example, the amount of data in the user buffer above a threshold, expected amount of future traffic exceeding a threshold, the user throughput below a threshold, there is active traffic in the UE, and/or the like.

In some other example embodiments, when certain criteria is satisfied, UE may request dual connectivity by signaling to PCell or another serving cell of MeNB. The criteria may be one or more of, for example, UE's measurements on potential cells on SCell list/carrier above a threshold, the amount of data in the user buffer exceeding a threshold, expected amount of future traffic exceeding a threshold, the user throughput below a threshold, there is active traffic in the UE, and/or the like. In some example embodiments, the network may enable UE to request dual connectivity by signaling UE. For example, the network may signal UE a list that indicates cells or carriers to which UE could request dual connectivity, and/or the criteria for UE requesting dual connectivity.

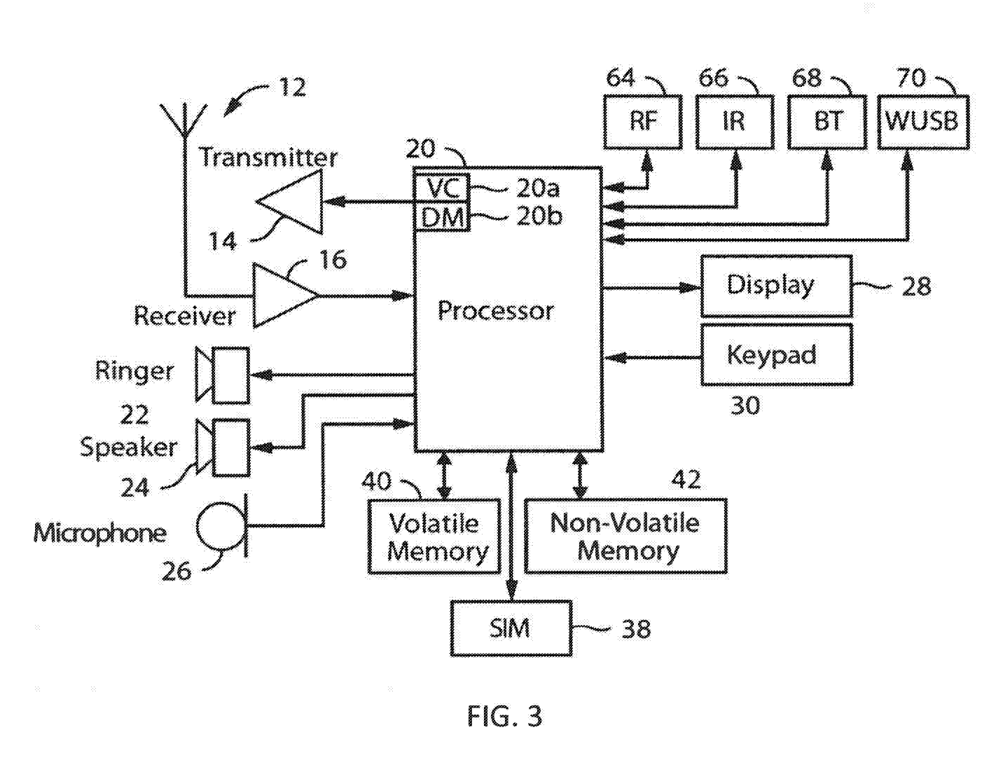

FIG. 3 illustrates a block diagram of an apparatus 10, in accordance with some example embodiments. The apparatus 10 (or portions thereof) may be configured to provide a user equipment, a communicator, a machine type communication device, a wireless device, a wearable device, a smartphone, a cellular phone, a wireless sensor/device (for example, a wireless device which is part of a distributed architecture in for example, a car, a vehicle, a robot, a human, and/or the like). In the case of the distributed architecture, the wireless device may communicate via one or more transceiver modules and/or via a hub that may hide the actual distribution of functionalities from the network.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit, ASIC, or field programmable gate array (FPGA), and/or the like) or some combination thereof. Accordingly, although illustrated in FIG. 3 as a single processor, in some embodiments the processor 20 comprises a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the apparatus 10 may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be subsequently developed.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor may additionally comprise an internal voice coder, VC, 20a, an internal data modem, DM, 20b, and/or the like. Further, the processor may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus 10 may comprise a battery for powering various circuits related to the apparatus, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 3, apparatus 10 may also include one or more mechanisms for sharing and/or obtaining data. For example, the apparatus may comprise a short-range radio frequency, RF, transceiver and/or interrogator 64, so data may be shared with and/or obtained from electronic devices in accordance with RF techniques. The apparatus may comprise other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise a memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment. The memories may comprise an identifier, such as for example, an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein with respect to a user equipment.

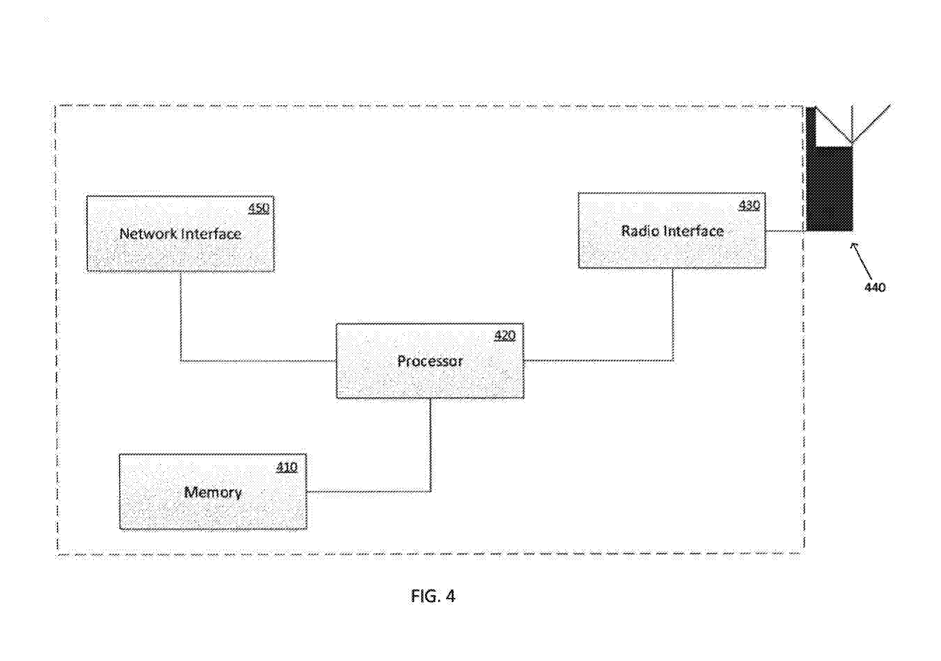

FIG. 4 depicts an example implementation of a base station in accordance with some embodiments of the invention, such as MeNB 101. The base station may include one or more antennas 440 configured to transmit via a downlink and configured to receive uplinks via the antenna(s). The base station may further include a plurality of radio interfaces 430 coupled to the antenna 440. The radio interfaces 430 may correspond to a plurality of radio access technologies including one or more of LTE, WLAN, Bluetooth, Bluetooth low energy, NFC, radio frequency identifier (RFID), ultrawideband (UWB), ZigBee, ANT, and the like. The radio interface 430 may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).). The base station may further include one or more network interfaces 450, for receiving and transmitting to other base stations and/or core networks. The base station may further include one or more processors, such as processor 420, for controlling the interfaces 430 and 450 and for accessing and executing program code stored in memory 410. In some example embodiments, the memory 410 includes code, which when executed by at least one processor causes one or more of the operations described herein with respect to a base station.

Without in any way limiting the scope, interpretation, or application of the claims appearing below, a technical effect of one or more of the example embodiments disclosed herein may include enabling autonomous releasing of dual connectivity by a user equipment.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims. The term “based on” includes “based at least in part on”.

1-26. (canceled)

27. A method, comprising:
receiving, by a user equipment, configuration information including a timer value associated with user data inactivity;
starting or restarting a timer when user data is active in at least one cell of a secondary cell group but not active in a cell of a master cell group; and
releasing dual connectivity if the timer expires.

28. The method of claim 27, wherein the master cell group comprises a group of serving cells associated with a master base station.

29. The method of claim 27, wherein the secondary cell group comprises a group of serving cells associated with a secondary base station.

30. The method of claim 27, wherein releasing dual connectivity comprises releasing connections to cells of the secondary cell group.

31. The method of claim 27, further comprising: stopping sending at least one of buffer status report and power headroom report to cells of the secondary cell group.

32. The method of claim 27, wherein the configuration information is carried on a radio resource control message.

33. The method of claim 32, wherein the radio resource control message comprises RRCConnectionReconfiguration message for adding or configuring a cell of the secondary cell group.

34. The method of claim 27, wherein the timer value is specific for a cell of the secondary cell group or common for cells of the secondary cell group.

35. An apparatus, comprising:
at least one processor; and
at least one memory including computer program code,
wherein the at least one memory and the computer program code are configured to, with the at least one processor, cause the apparatus to at least:
receive configuration information including a timer value associated with user data inactivity;
start or restart a timer when user data is active in at least one cell of a secondary cell group but not active in a cell of a master cell group; and
release dual connectivity if the timer expires.

36. The apparatus of claim 35, wherein the master cell group comprises a group of serving cells associated with a master base station.

37. The apparatus of claim 35, wherein the secondary cell group comprises a group of serving cells associated with a secondary base station.

38. The apparatus of claim 35, wherein releasing dual connectivity comprises releasing connections to cells of the secondary cell group.

39. The apparatus of claim 35, wherein releasing dual connectivity comprises releasing dual connectivity when there is bearer split between a master base station and a secondary base station.

40. The apparatus of claim 35, wherein the apparatus is further caused to: stop sending at least one of buffer status report and power headroom report to cells of the secondary cell group.

41. The apparatus of claim 35, wherein the configuration information is carried on a radio resource control message.

42. The apparatus of claim 41, wherein the radio resource control message comprises RRCConnectionReconfiguration message for adding or configuring a cell of the secondary cell group.

43. The apparatus of claim 35, wherein the timer value is specific for a cell of the secondary cell group or common for cells of the secondary cell group.

44. The apparatus of claim 35, wherein the apparatus is further caused to: send information on the releasing to a master base station.

45. An apparatus, comprising:
at least one processor; and
at least one memory including computer program code,
wherein the at least one memory and the computer program code are configured to, with the at least one processor, cause the apparatus to at least:
transmit configuration information including a timer value associated with user data inactivity, wherein the timer value is associated with release of dual connectivity if a timer which counts time of user data inactivity expires.

46. The apparatus of claim 45, wherein the apparatus is further caused to: receive information on releasing dual connectivity from a user equipment.
